(19) United States
(12) Patent Application Publication
(10) Pub. No.: US 2009/0167748 A1
(43) Pub. Date: Jul. 2, 2009

(54) PLASMA DISPLAY APPARATUS, DRIVING METHOD THEREOF AND DRIVING IC

(75) Inventors: Mutsuhiro MORI, Mito (JP); Takuo Nagase, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/342,457

(22) Filed: Dec. 23, 2008

(30) Foreign Application Priority Data
Dec. 27, 2007 (JP) 2007-335519

(51) Int. Cl. G09G 5/00; G09G 3/28

(52) U.S. Cl. 345/212; 345/60

(57) ABSTRACT

A plasma display apparatus wherein during the period for which the lighting of the AC type PDP panel is sustained, the electrodes on one side of the panel are maintained at a constant potential whereas the electrodes on the other side of the panel are supplied alternately with a positive voltage and a negative voltage, the plasma display apparatus having a means that feeds power flowing toward the address power source into a separate power source.

### BACKGROUND OF THE INVENTION

This invention relates to a plasma display (PDP) apparatus, a driving method and a driving IC for the PDP apparatus.

Recently, AC type PDP apparatuses have been rapidly popularized since they are not only thin in structure but also can provide screens greater in size than the conventional TV receivers using cathode ray picture tubes. However, they have disadvantages, too. The large screen needs large power consumption and high production cost.

In the display panel of the AC type PDP apparatus, the X electrodes and the Y electrodes are disposed alternately and in nearly parallel to one another, and the address electrodes (hereafter referred to as A electrodes) are arranged at right angle with respect to the X and Y electrodes to form a two-dimensional matrix.

FIG. 11 schematically shows the plasma panel 1 (referred to also as display panel) of a conventional AC type PDP apparatus and its associated main drive circuits. This apparatus is such that the sustain circuits are provided only for the Y electrodes while the potentials at the X electrodes are fixed, i.e. kept at a constant value by being connected with the chassis (housing) of the PDP apparatus. Thus, the X electrodes need not be provided with sustain circuits. This configuration enables the drive by the one-sided 5 sustain circuits. Prior art documents ever reported in relation to the drive by one-sided sustain circuits include, for example, JP-3666607 and Article “New Two Stage Recovery (TSR) Driving Method for Low Cost AC Plasma Display Panel”, pp 461-464, IDW/AD, '05 (The 12th International Display Workshops/Asia Display 2005). Each of the documents discloses a PDP apparatus wherein only the Y electrodes are provided with sustain circuits, in comparison with the PDP apparatuses now on the market which have both the X and Y electrodes provided with sustain circuits. Those disclosed PDP apparatuses, therefore, are advantageous in that they can contribute to the reduction of production cost. The above mentioned article proposes such drive waveforms as shown in FIG. 12 of the attached drawings, which serve to light the AC type PDP apparatus having one-sided sustain circuits. The drive sequence is divided into three periods: reset period during which electric charges in the respective display cells of the plasma panel are eliminated and the plasma panel is initialized; address period during which wall charges are formed in those of the display cells which must be lit; and sustain period during which the display cells with wall charges formed therein are repeatedly lit. This is called “subfield” and the brightness in each subfield is controlled by changing the number of repeated lighting. One field consists of 8˜12 subfield, in which the numbers of repeated lighting varies from one subfield to another. The combination of subfields having different numbers of repeated lighting produces intermediate tones in brightness. The one field is run in, for example, 1/60 second and animated pictures are produced by providing 60 fields for one second.

During the reset period in FIG. 12, the sustain voltage +Vs to be applied to the Y electrode during the sustain period is also applied to the Y electrode, and Vset (circuit for applying this potential is not shown) is superposed on +Vs. Accordingly, a voltage is developed to cause electric discharge between the Y electrode and the associated X electrode kept at the ground potential. By gradually increasing the amplitude of Vset, weak electric discharge (referred to as positive sawtooth wave reset) takes place between the X and Y electrodes. At this time, the A electrode is maintained at a potential equal to the potential Va that is to be developed during the address period. Thereafter, a negative potential is applied to the Y electrode (i.e. negative sawtooth wave reset takes place) to eliminate or reduce the wall charges between the X and Y electrodes and to uniformly initialize the entire display cells.

During the address period, Vscb+Vsc (circuit for applying this potential is not shown) is then applied to the Y electrode, and the address potential Va is applied to the A electrode of the display cell to be lit. Electric discharge takes place between the Y and A electrodes so that wall charges are formed in the desired display cell.

During the following sustain period, the sustain voltages +Vs and −Vs are alternately applied to the Y electrode, and the display cell in which wall charges were accumulated is lit every time the potential at the Y electrode is switched. At this time, the address electrode drive circuit 12 applies Va or 0 to the A electrode in response to +Vs or −Vs being applied to the Y electrode, respectively. To apply +Vs to the Y electrode, the Y electrode drive circuit 20 is used, and IGBT (T3) and IGBT (T4) are turned off and on, respectively. To apply −Vs to the Y electrode, on the other hand, T3 and T4 are turned on and off, respectively. Further, to apply Va to the A electrode, the address electrode drive circuit 12 causes MOSFET (T2) and MOSFET (T1) to be turned off and on, respectively, whereas to apply 0 volt to the A electrode, the address electrode drive circuit 12 causes MOSFET (T2) and MOSFET (T1) to be turned on and off, respectively. Diodes D1, D2, D3, D4 serve to clamp the potential at the A electrode to the power source voltage Va or the ground potential, or the potential at the Y electrode at +Vs or −Vs.

If, however, such a drive sequence as shown in FIG. 12 is employed, large power flows from the Y electrode into the A electrode during the sustain period. This large power inflow causes the potential at the power source Va to rise, resulting in unstable operation. Consequently, during the address period, the degree of forming wall charges due to Va varies from one display cell to another with the result that brightness becomes uneven. The present inventor has discovered this drawback. In addition to this, the present inventor has also discovered that during the reset period, not only weak electric discharge takes place between the Y and X electrodes, but also electric discharge takes place between the Y and A electrodes, so that positive sawtooth reset cannot be properly performed. This is a problem that must be solved. The present inventor has further discovered that the electric discharge between the Y and A electrodes takes place even during the reset or sustain period other than the address period so that fluorescent material deposited on the A electrode is damaged and that deterioration of brightness is accelerated. This is another problem that must be solved.

### SUMMARY OF THE INVENTION

The objects of this invention, which has been made to eliminate the above mentioned drawback and to solve the above mentioned problems, are to stabilize the power source voltage Va during the sustain period; to suppress the electric discharge between the Y and A electrodes during the reset period, thereby preventing brightness deterioration and reducing power consumption; and to normally perform the positive sawtooth wave resetting between the Y and X electrodes, thereby preventing erroneous electric discharges and discharge failures, all these objects having not been able to be attained by conventional AC type PDP apparatuses with one-sided sustain drive circuits.

To attain the above mentioned objects, there is provided a plasma display apparatus comprising: a plurality of first electrodes; a plurality of second electrodes disposed approximately in parallel to the first electrodes and forming display cells together with the adjacent first electrodes, electric discharges taking place between the first and second electrodes forming the display cells; a plurality of third electrodes disposed in crisscross to the first and second electrodes; a plurality of first drive circuit boards for supplying current from a first power source to the third electrodes; a plurality of first switching elements located in the first drive circuit boards, for connecting the high-voltage terminals of the first power source with the third electrodes; and a plurality of second switching elements located in the first drive circuit boards, for connecting the low-voltage terminals of the first power source with the third electrodes,

wherein during the period for which the lighting of the plasma display panel is sustained, the first electrodes are maintained at a first fixed potential; the second electrodes (Y) are supplied alternately with a first voltage positive with respect to the potential of the first electrodes and a second voltage negative with respect to the potential of the first electrodes; and the potentials at the third electrodes vary in approximate synchronization with the waveforms of the voltages of the second electrodes; and wherein a means is provided that feeds at least part of power flowing toward the first power source from the third electrodes, into a second power source having a second voltage different from the voltage of the first power source.

Also, to attain the above mentioned objects, there is provided a plasma display apparatus comprising: a plurality of first electrodes; a plurality of second electrodes disposed approximately in parallel to the first electrodes and forming display cells together with the adjacent first electrodes, electric discharges taking place between the first and second electrodes forming the display cells; a plurality of third electrodes disposed in crisscross to the first and second electrodes; a plurality of first drive circuit boards for supplying current from a first power source to the third electrodes; a plurality of first switching elements located in the first drive circuit boards, for connecting the high-voltage terminals of the first power source with the third electrodes; and a plurality of second switching elements located in the first drive circuit boards, for connecting the low-voltage terminals of the first power source with the third electrodes,

wherein during the period for which the lighting of the plasma display panel is sustained, the first electrodes are maintained at a first fixed potential; the second electrodes are supplied alternately with a first voltage positive with respect to the potential of the first electrodes and a second voltage negative with respect to the potential of the first electrodes; and the breakdown voltage of the second switching elements is higher than that of the first switching elements.

Further, to attain the above mentioned objects, there is provided a plasma display apparatus comprising: a plurality of first electrodes; a plurality of second electrodes disposed approximately in parallel to the first electrodes and forming display cells together with the adjacent first electrodes, electric discharges taking place between the first and second electrodes forming the display cells; a plurality of third electrodes disposed in crisscross to the first and second electrodes; a plurality of first drive circuit boards for supplying current from a first power source to the third electrodes; a plurality of first switching elements located in the first drive circuit boards, for connecting the high-voltage terminals of the first power source with the third electrodes; and a plurality of second switching elements located in the first drive circuit boards, for connecting the low-voltage terminals of the first power source with the third electrodes,

wherein during the period for which the lighting of the plasma display panel is sustained, the first electrodes are maintained at a first fixed potential; the second electrodes are supplied alternately with a first voltage positive with respect to the potential of the first electrodes and a second voltage negative with respect to the potential of the first electrodes; and at least the second switching elements are IGBTs (Insulated Gate Bipolar Transistors).

Still further, to attain the above mentioned objects, there is provided a plasma display apparatus comprising: a plurality of first electrodes; a plurality of second electrodes disposed approximately in parallel to the first electrodes and forming display cells together with the adjacent first electrodes, electric discharges taking place between the first and second electrodes forming the display cells; a plurality of third electrodes disposed in crisscross to the first and second electrodes; a plurality of first drive circuit boards for supplying current from a first power source to the third electrodes; a plurality of first switching elements located in the first drive circuit boards, for connecting the high-voltage terminals of the first power source with the third electrodes; and a plurality of second switching elements located in the first drive circuit boards, for connecting the low-voltage terminals of the first power source with the third electrodes,

wherein during the period for which the lighting of the plasma display panel is sustained, the first electrodes are maintained at a first fixed potential; the second electrodes are supplied alternately with a first voltage positive with respect to the potential of the first electrodes and a second voltage negative with respect to the potential of the first electrodes; and the maximum voltage applied to the third electrodes during the reset period is higher than the maximum voltage applied to the third electrodes at the time of addressing during the address period.

Moreover, to attain the above mentioned objects, there is provided a method for driving the plasma display apparatus mentioned above.

Furthermore, to attain the above mentioned objects, there is provided an IC for driving the plasma display apparatus mentioned above.

By providing a means for feeding the power flowing from the Y electrodes to the A electrodes during the sustain period, into a separate power source having a voltage different from the voltage of the power source Va, several advantages can be obtained as folllows. Namely, the potential at the power source Va is stabilized, the formation of wall charges due to Va during the address period is made uniform, and unevenness in brightness is eliminated. Moreover, by effectively reusing the power retrieved into the separate power sources, it is possible to reduce the power consumption in the PDP apparatus. Furthermore, by making the maximum voltage applied to the A electrodes during the reset period, higher than the maximum voltage applied to the A electrodes during the address period, the electric discharges taking place between the Y and A electrodes during the reset period are suppressed so that positive sawtooth wave resetting can be normally performed between the Y and X electrodes and that erroneous discharges or discharge failures during the sustain period can be prevented. Additionally, by suppressing electric discharges between the Y and A electrodes, deterioration of brightness is lessened so that the lifetime of the PDP apparatus can be prolonged.

According to this invention, the potential Va of the address power source, i.e. first power source, can be stabilized, the unevenness of wall charges formed in the display cells during the address period can be lessened, and overall display can be uniform and stabilized. Also, since Vas can be set high, the deterioration of brightness can be lessened, the lifetime of the PDP apparatus can be prolonged, and power consumption by the PDP apparatus can be reduced. Additionally, since Var can be set high at the time of positive sawtooth wave resetting during the reset period, electric discharges between the Y and A electrodes become hard to take place and the positive sawtooth wave resetting between the desired Y and X electrodes can be performed normally. Accordingly, it becomes possible to provide a plasma display apparatus free from erroneous electric discharges and failures in electric discharge, a method and an IC for driving such a plasma display apparatus.

Other objects, features and advantages of the invention will become apparent from the following description of the embodiments of the invention taken in conjunction with accompanying drawings.

### BRIEF DESCRIPTION OF THE DRAWINGS

FIG. 1 schematically shows an AC type PDP apparatus as a first embodiment of this invention;

FIG. 2 graphically shows the driving waveforms used preferably in this invention;

FIG. 3 graphically shows the relationships between the power fed into the power source Vac and the address voltage Vas during the sustain period;

FIG. 4 graphically shows the dependence of brightness deterioration on time lapse;

FIG. 5 graphically shows the output characteristics of a MOSFET and an IGBT;

FIG. 6 schematically shows an AC type PDP apparatus as a second embodiment of this invention;

FIG. 7 schematically shows an AC type PDP apparatus as a third embodiment of this invention;

FIG. 8 schematically shows an AC type PDP apparatus as a fourth embodiment of this invention;

FIG. 9 schematically shows an AC type PDP apparatus as a fifth embodiment of this invention;

FIG. 10 schematically shows an AC type PDP apparatus as a sixth embodiment of this invention;

FIG. 11 schematically shows an example of a conventional AC type PDP apparatus; and

FIG. 12 graphically shows the driving waveforms used preferably in the conventional AC type PDP apparatus.

### DETAILED DESCRIPTION OF THE INVENTION

Embodiments of this invention will now be described in detail with reference to the attached drawings.

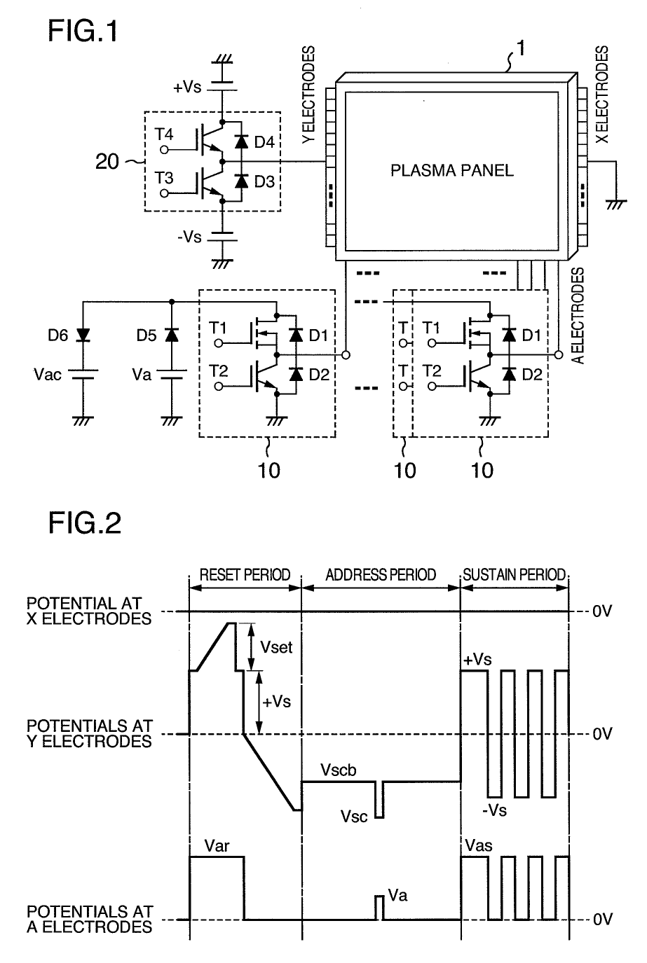

FIG. 1 schematically shows an AC type PDP apparatus as a first embodiment of this invention. The X electrodes of the plasma panel 1 are kept invariably at the ground potential. The Y electrodes of the plasma panel 1 are provided with so many drive circuits 20, respectively. Voltages +Vs and −Vs are alternately applied to the Y electrode by alternately turning the IGBTs T3 and T4 on and off during the sustain period. The driving waveforms, which are preferably used in this invention, generated by the address electrode drive circuits 10 connected with the A electrodes of the plasma panel 1 will be described in detail in reference to FIG. 2.

During the reset period, a voltage Vset is gradually superposed on the voltage +Vs which has been already applied to the Y electrode for positive sawtooth wave resetting. At this time, the transistors T1, T2 of the address electrode drive circuit 10 are both turned off. With increasing potential at the Y electrode, the potential Var at the A electrode increases as a result of displacement current flowing between the Y and A electrodes so that the potential Var at the A electrode is clamped at a voltage Vac through the diodes D1, D6. Or, alternatively, the potential Var is kept at a voltage somewhere between Vac and Va. Then, when the potentials +Vs and Vset are removed from the Y electrode, the potential Var at the A electrode during the reset period is clamped to the ground potential via the diode D2.

In the address period that follows, a voltage Vsc, which is supplied from a scanning IC (not shown in FIG. 1), is superposed on the voltage Vscb, which has been already applied to each of the Y electrodes that were successively selected, as is the same with the conventional AC type PDP apparatus. When Vscb and Vsc are applied to the Y electrode of the display cell that was expected to emit light for display, the address voltage Va is applied to the associated A electrode so that electric discharge takes place between the Y and A electrodes to accumulate wall charges. At this time, Va turns the transistor T1 on and the transistor T2 off and is applied to the A electrode via the diode D5.

In the sustain period reached finally, voltages +Vs and −Vs are alternately applied to the Y electrode, electric discharge takes place between the Y electrode and the associated X electrode, and the associated display cell emits light. At this time, the transistors T1 and T2 of the address electrode drive circuit 10 are both turned off. Accordingly, +Vs is applied to the Y electrode and when the electric discharge takes place, the potential Vas at the A electrode during the sustain period is clamped via the diodes D1, D6 at Vac in the drive circuit 10 shown in FIG. 1, due to the displacement current between the Y and A electrodes. Or, alternatively, Vas is kept at a voltage somewhere between Vac and Va. When the potential at the Y electrode is changed to −Vs, Vas is clamped via the diode D2 at the ground potential.

The configuration proposed according to this invention and described above has three principal advantages.

The first advantage is as follows. Power flowing into the A electrode during the sustain period can be transferred to the power source Vac other than the power source Va so that the power source Va to be used during the address period can be stabilized. As a result, the unevenness of wall charges formed in the display cells during the address period is lessened, contributing to the advantage that uniform and stabilized display can be obtained. Power consumption can be effective if the power transferred to the power source Vac can be utilized to energize, for example, other ICs in the PDP apparatus.

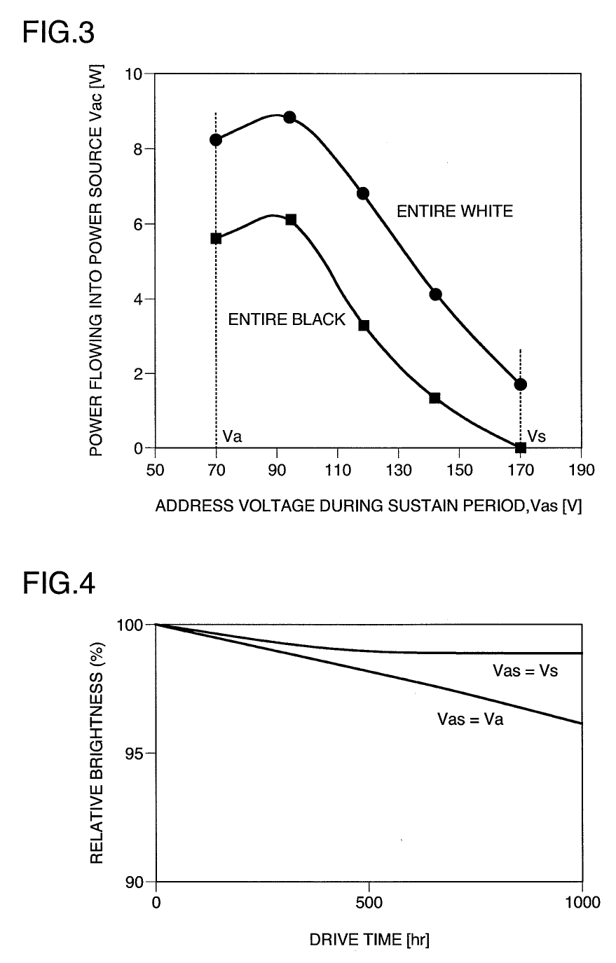

FIG. 3 graphically shows the relationships between the power fed into the power source Vac and the address voltage Va, in the sustain period (synonymous to “period of sustained discharge”). In the experiment made to obtain the result shown in FIG. 3, Vas was measured while Vac was being varied, and the power fed into the power source Vac was obtained. Accordingly, Vac and Vas assume almost the same potential value although there are the diodes D1, D6 between them. As apparent from FIG. 3, if Vas is almost the same as Va, power of 5.7 W and power of 8.2 W are fed into the power source Vac for the panel displays of entire black and entire white, respectively. Thus, it is understood that the power can be retrieved and effectively reused.

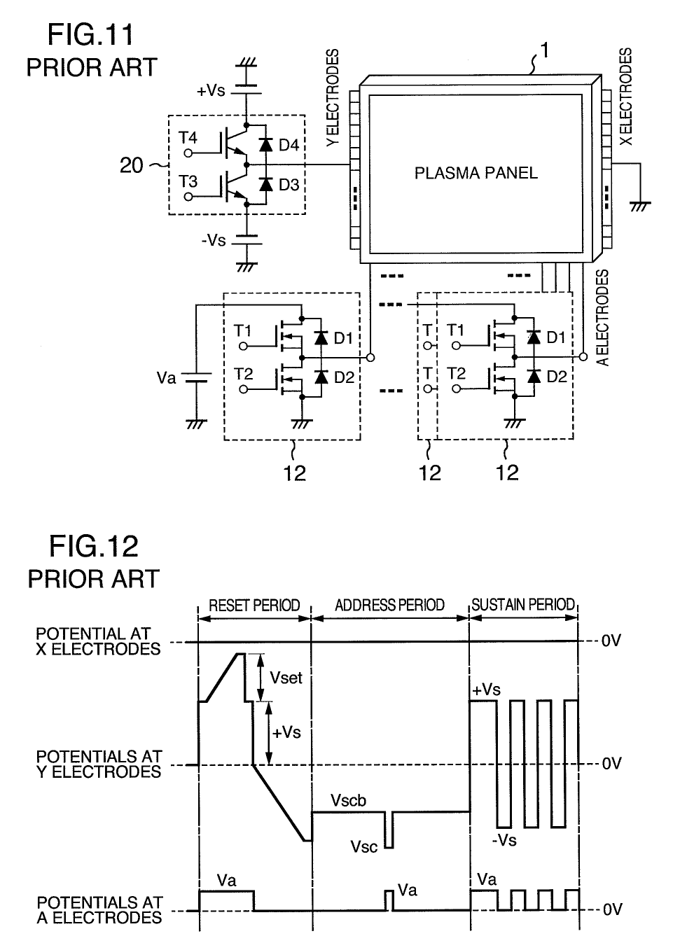

The power that can be retrieved and reused according to this embodiment of the invention, caused the instability of the power source voltage Va, the uneven brightness and the erroneous discharges in the conventional configuration shown in FIG. 11. When the potential Vas is increased with the power source voltage Vac kept high, power fed into the power source Vac increases until Vas reaches around 90 V. If Vas is still increased, the fed power decreases. When Vas is increased up to about Vs, there is no power inflow into the power source Vac in the case of the entire black display. Accordingly, the power fed to the Y electrode can be used effectively for the electric charge and discharge between the X and Y electrodes so that power consumption can be economized. This situation occurs also in the case where the display panel is lit in the entire white display mode. If Vas is increased up to about Vs, then the power flowing from the Y electrode to the A electrode decreases, the power fed to the Y electrode is effectively used for the electric charge and discharge between the X and Y electrodes and for the energy to cause light emission, and therefore an AC type PDP apparatus having a high efficiency can be realized. If Vac is further increased, Vas becomes high correspondingly so that power inflow into the power source Vac decreases.

The second advantage is as follows. If Vas is set high, the deterioration of brightness is lessened and the lifetime of the plasma panel becomes longer.

FIG. 4 graphically shows the dependence of brightness deterioration on time lapse when Vas is set at Va and Vs. The inventor of this invention has found out that when Vas is set high to suppress the current flowing into the power source Vac, the brightness deterioration is lessened. This is ascribed to the fact that the number of ionized Xe (xenon) atoms bombarding the fluorescent material deposited on the A electrode at the time of emitting light is lessened, thereby the deterioration of the fluorescent material being lessened. Namely, the underlying principle is that if Vas is set high, the bombarding frequency of Xe ions is lowered, resulting in the decrease in the current flowing into the power source Vac and therefore the decrease in the power consumption.

The third advantage is as follows. If the A electrode potential Var during the reset period is set higher than the A electrode potential Va during the address period, the electric discharge between the Y and A electrodes is suppressed at the time of positive sawtooth wave resetting during the reset period so that the desired positive sawtooth wave resetting can be performed normally. Accordingly, along with the ensuing negative sawtooth wave resetting, the wall charges of respective display cells can be eliminated or lessened so that the respective display cells can be uniformly initialized. Thus, wall charges are stably formed in the respective display cells during the address period and, as a result, errors and failures in electric discharge during the sustain period can be prevented.

In order to control the driving waveform in such a manner as shown in FIG. 2, it is preferable to set the breakdown voltage and withstand voltage of the transistor T2 higher than those of the transistor T1. The reason is as follows. If the power from the A electrode is to be retrieved into the power source Vac during the reset period or the sustain period, the T1 and T2 are turned off and the potential Var or Vas, high enough, developed at the A electrode is applied to T2. On the other hand, when T2 is turned on and when the A electrode is clamped at the ground potential through the diode D2, the potential Va is applied to T1 via D5. Since Va is lower than Vac (or Var, Vas), a transistor having the breakdown voltage and withstand voltage lower than those of T2 can serve as T1. Thus, since a switching element having a lower conduction resistance can be used, a low power loss circuit can be realized.

If Vac is allowed to be a potential equal to Vs (about 170 V), the breakdown voltage of the switching element T2 must be higher than 200 V. On the other hand, if Va is set at 70 V, the breakdown voltage of T1 can be about 100 V. It is to be noted that the breakdown voltages of D1 and D2 must also be equal to those of T1 and T2, respectively. Further, it is needless to say that D5 and D6 must have withstand voltages not less than the voltage difference between Vac and Va (i.e. 100 V=170 V−70 V).

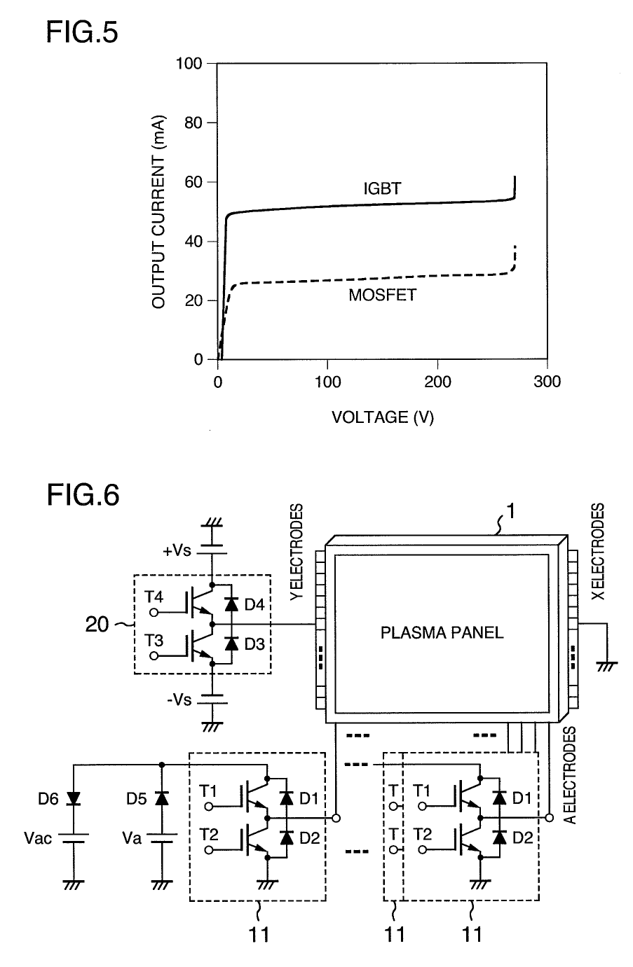

FIG. 5 graphically shows the output characteristics of a MOSFET and an IGBT which have the same silicon surface area and the same withstand voltage. It is found out that for the same silicon surface area, the IGBT can produce higher power and therefore have a greater drive capability, than the conventional MOSFET. As well known, only electrons carry current in MOSFET, whereas holes as well as electrons carry current in IGBT. The present inventor's investigation has revealed that the IGBT has the saturation current 1.6˜1.8 times larger than that of the MOSFET. It is characteristic of the PDP apparatus that the IGBTs are operated in the region of saturation currents. No prior example has been found where IGBTs are used in the address electrode drive circuits 10. Therefore, the AC type PDP apparatus of one side sustain drive mode should preferably use IGBTs as T2s to enhance the drive capability by providing T2 with the breakdown voltage higher than that of T1 and clamping the associated A electrode at the ground potential, so that the operating speed of the drive circuits can be advantageously increased and that the display can also be advantageously stabilized.

Even in the case of a drive IC wherein a plurality of address electrode drive circuits 10 are integrated, the concept of the above described embodiment can be well implemented. Such an IC configuration enables each address electrode drive circuit 10 to be miniaturized.

FIG. 6 schematically shows an AC type PDP apparatus as another embodiment of this invention. This second embodiment of the present invention is characterized in that IGBTs serve also as transistors T1s. Since enhancing the drive capability of T1 contributes to enhancing the capability of retrieving power to the power source Vac and therefore to reducing the power consumption, this configuration can effectively promote energy conservation. Moreover, the IC configuration of the plural address electrode drive circuits 10 enables the entire drive circuit to be miniaturized and also can contribute to the reduction of costs.

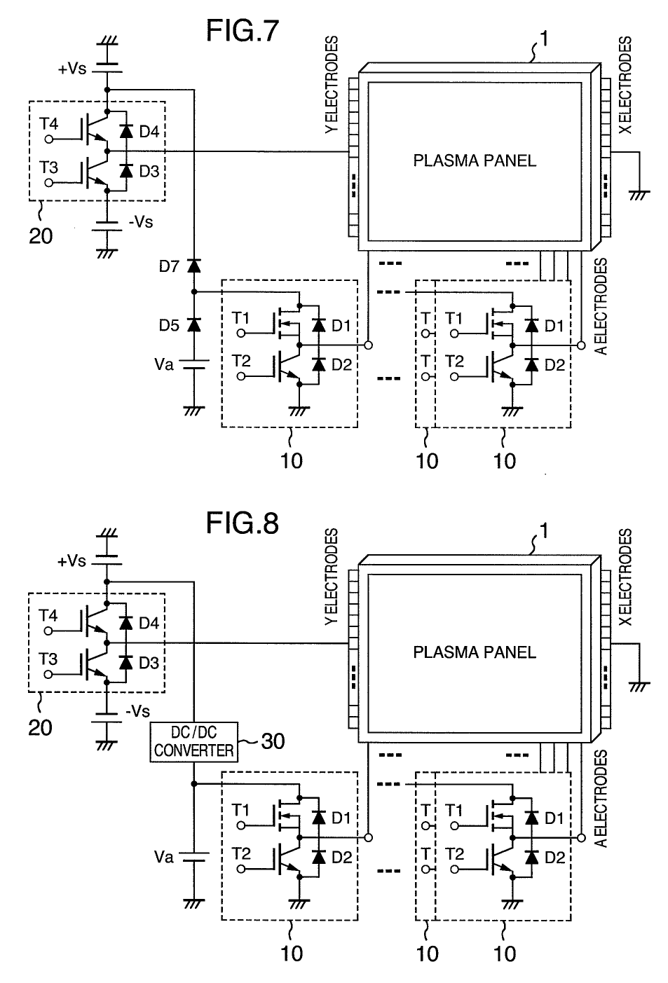

FIG. 7 schematically shows an AC type PDP apparatus as still another embodiment of this invention. This third embodiment of the present invention is characterized in that a diode D7 is introduced to connect its cathode electrode with the potential +Vs. This configuration enables Var and Vas to be easily clamped at +Vs. Accordingly, power consumption can be reduced as in FIG. 3, the lifetime of brightness can be prolonged as in FIG. 4, and the normal sawtooth wave resetting during the reset period can be easily realized as described above. In FIG. 7 is shown the simplest way of clamping the desired point of circuit at +Vs.

FIG. 8 schematically shows an AC type PDP apparatus as yet another embodiment of this invention. This fourth embodiment of the present invention is characterized in that a DC/DC converter 30 is introduced to step up Var or Vac to +Vs. This configuration will also enjoy such advantages as described with the preceding embodiments.

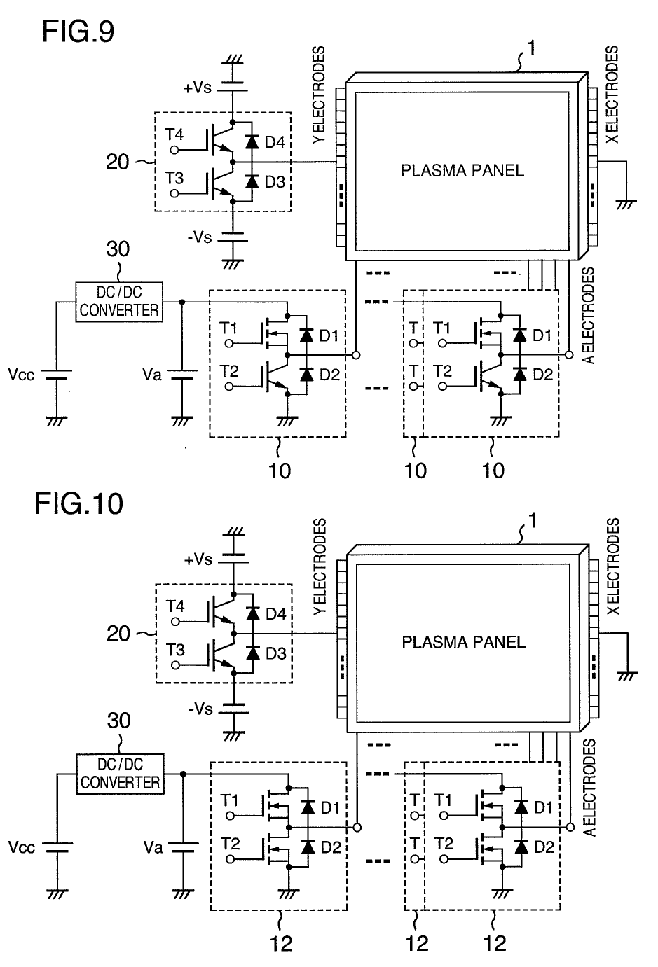

FIGS. 9 and 10 schematically show AC type PDP apparatuses as further embodiments of this invention, wherein the power to be retrieved to a power source Vcc different from the power source Va is subjected to voltage conversion. For example, the power source Vcc may be a 5V power source for use with an LSI chip. By quickly switching the power inflow toward the power source Va to the power source Vcc through a DC/DC converter 30, Va can be stabilized, wall charges can be securely formed during the address period, the unevenness of brightness can be prevented from being generated during the ensuing sustain period, and finally electric power can be effectively utilized. As shown in FIG. 10, it is also possible to use MOSFETs as T1s and T2s of the address electrode drive circuits 12 as in the conventional circuit configuration. In such a case, compatibility is enhanced and therefore cost reduction can be effected through the scale merit of mass production.

It should be further understood by those skilled in the art that although the foregoing description has been made on embodiments of the invention, the invention is not limited thereto and various changes and modifications may be made without departing from the spirit of the invention and the scope of the appended claims.

1. A plasma display apparatus comprising:
a plurality of first electrodes;
a plurality of second electrodes disposed approximately in parallel to the first electrodes and forming display cells together with the adjacent first electrodes, electric discharges taking place between the first and second electrodes forming the display cells;
a plurality of third electrodes disposed in crisscross to the first and second electrodes;
a plurality of first drive circuit boards for supplying current from a first power source to the third electrodes;
a plurality of first switching elements located in the first drive circuit boards, for connecting the high-voltage terminal of the first power source with the third electrodes; and
a plurality of second switching elements located in the first drive circuit boards, for connecting the low-voltage terminal of the first power source with the third electrodes,
wherein during the period for which the lighting of the plasma display panel is sustained, the first electrodes are maintained at a first fixed potential; the second electrodes are supplied alternately with a first voltage positive with respect to the potential of the first electrodes and a second voltage negative with respect to the potential of the first electrodes; and the potentials at the third electrodes vary in approximate synchronization with the waveforms of the voltages of the second electrodes; and wherein a means is provided that feeds at least part of power flowing toward the first power source from the third electrodes, into a second power source having a second voltage different from the voltage of the first power source.

2. A plasma display apparatus as claimed in claim 1, further comprising a chassis for mechanically supporting the plasma display panel, wherein the first electrodes are electrically connected with the chassis.

3. A plasma display apparatus as claimed in claim 2, wherein the lower potential terminal of the first power source is maintained at the chassis potential.

4. A plasma display apparatus as claimed in claim 2, wherein the chassis potential is the ground potential.

5. A plasma display apparatus as claimed in claim 1, wherein the second potential at the higher potential terminal of the second power source is higher than the first potential at the higher potential terminal of the first power source.

6. A plasma display apparatus as claimed in claim 1, wherein the second potential is the same as the potential of the first voltage.

7. A plasma display apparatus as claimed in claim 1, wherein the first switching element consists of a first transistor and a first diode connected in inverse parallel with the first transistor whereas the second switching element consists of a second transistor and a second diode connected in inverse parallel with the second transistor.

8. A plasma display apparatus as claimed in claim 1, wherein the first and second transistors are both turned off during the period for which the plasma panel is being lit.

9. A plasma display apparatus as claimed in claim 1, wherein at least the second transistors are IGBTs.

10. A plasma display apparatus as claimed in claim 1, having an integrated circuit configuration wherein plural pairs of the first and second switching elements are integrated to be able to drive the plural third electrodes.

11. A plasma display apparatus as claimed in claim 1, further comprising a third diode connected between the first power source and each of the first switching elements, for forwardly conducting current from the first power source to the first switching element; and a fourth diode connected between the second power source and each of the first switching elements, for forwardly conducting current from the first switching element to the second power source.

12. A plasma display apparatus as claimed in claim 1, wherein the switching elements for supplying the second electrodes alternately with the first voltage positive with respect to the potential of the first electrodes and the second voltage negative with respect to the potential of the first electrodes, are all IGBTs.

13. A plasma display apparatus comprising:
a plurality of first electrodes;
a plurality of second electrodes disposed approximately in parallel to the first electrodes and forming display cells together with the adjacent first electrodes, electric discharges taking place between the first and second electrodes forming the display cells;
a plurality of third electrodes disposed in crisscross to the first and second electrodes;
a plurality of first drive circuit boards for supplying current from a first power source to the third electrodes;
a plurality of first switching elements located in the first drive circuit boards, for connecting the high-voltage terminal of the first power source with the third electrodes; and
a plurality of second switching elements located in the first drive circuit boards, for connecting the low-voltage terminal of the first power source with the third electrodes,
wherein during the period for which the lighting of the plasma display panel is sustained, the first electrodes are maintained at a first fixed potential; the second electrodes are supplied alternately with a first voltage positive with respect to the potential of the first electrodes and a second voltage negative with respect to the potential of the first electrodes; and the breakdown voltage of the second switching elements are higher than that of the first switching elements.

14. A plasma display apparatus comprising:
a plurality of first electrodes;
a plurality of second electrodes disposed approximately in parallel to the first electrodes and forming display cells together with the adjacent first electrodes, electric discharges taking place between the first and second electrodes forming the display cells;
a plurality of third electrodes disposed in crisscross to the first and second electrodes;
a plurality of first drive circuit boards for supplying current from a first power source to the third electrodes;
a plurality of first switching elements located in the first drive circuit boards, for connecting the high-voltage terminal of the first power source with the third electrodes; and
a plurality of second switching elements located in the first drive circuit boards, for connecting the low-voltage terminal of the first power source with the third electrodes,
wherein during the period for which the lighting of the plasma display is sustained, the first electrodes are maintained at a first fixed potential; the second electrodes are supplied alternately with a first voltage positive with respect to the potential of the first electrodes and a second voltage negative with respect to the potential of the first electrodes; and at least the second switching elements are IGBTs (Insulated Gate Bipolar Transistors).

15. A plasma display apparatus as claimed in claim 14, wherein at least the second switching elements are IGBTs and the breakdown voltages of the IGBTs are higher than those of the first switching elements.

16. A plasma display apparatus as claimed in claim 14, wherein the first and second switching elements are both IGBTs.

17. A plasma display apparatus as claimed in claim 14, wherein the maximum value of the potential differences applied to the third electrodes during the reset period is greater than the maximum value of the potential differences applied to the third electrodes at the addressing time during the address period.

18. A plasma display apparatus comprising:
a plurality of first electrodes;
a plurality of second electrodes disposed approximately in parallel to the first electrodes and forming display cells together with the adjacent first electrodes, electric discharges taking place between the first and second electrodes forming the display cells;
a plurality of third electrodes disposed in crisscross to the first and second electrodes;
a plurality of first drive circuit boards for supplying current from a first power source to the third electrodes;
a plurality of first switching elements located in the first drive circuit boards, for connecting the high-voltage terminal of the first power source with the third electrodes; and
a plurality of second switching elements located in the first drive circuit boards, for connecting the low-voltage terminal of the first power source with the third electrodes,
wherein during the period for which the lighting of the plasma display panel is sustained, the first electrodes are maintained at a first fixed potential; the second electrodes are supplied alternately with a first voltage positive with respect to the potential of the first electrodes and a second voltage negative with respect to the potential of the first electrodes; and the maximum value of the potential differences applied to the third electrodes during the reset period is greater than the maximum value of the potential differences applied to the third electrodes at the addressing time during the address period.

19. A method for driving the plasma display apparatuses as claimed in claim 1.

20. An IC for driving the plasma display apparatus as claimed in claim 1, wherein plural pairs of the first and second switching elements are integrated.
